(19) United States
(12) Patent Application Publication
(10) Pub. No.: US 2025/0313064 A1
(43) Pub. Date: Oct. 9, 2025

(54) THERMAL MANAGEMENT SYSTEM OF A VEHICLE

(71) Applicants: HYUNDAI MOTOR COMPANY, Seoul (KR); KIA CORPORATION, Seoul (KR)

(72) Inventors: Jong Won Kim, Cheonan-si (KR); Wan Je Cho, Hwaseong-si (KR)

(73) Assignees: HYUNDAI MOTOR COMPANY, Seoul (KR); KIA CORPORATION, Seoul (KR)

(21) Appl. No.: 18/914,849

(22) Filed: Oct. 14, 2024

(30) Foreign Application Priority Data
Apr. 9, 2024 (KR) 10-2024-0048002

(51) Int. Cl. B60H 1/32

(52) U.S. Cl. CPC B60H 1/32284; B60H 1/3205; B60H 1/3223

(57) ABSTRACT

A thermal management system of a vehicle is disclosed. The thermal management system of a vehicle is provided to control the amount of refrigerant and the system pressure in a refrigerant system depending on an operation mode. To this end, the thermal management system includes a gas-liquid separator and a compressor connected along a refrigerant line, a condenser, a receiver dryer, an expansion valve, an evaporator, a storage line connecting the receiver dryer and the gas-liquid separator to each other and enabling a refrigerant to flow by a pressure difference therebetween, a supply line connected from a refrigerant line at an outlet of the compressor to the storage line, and a valve device provided at the storage line and the supply line and configured to control refrigerant storage at the storage line and refrigerant discharge from the storage line to the receiver dryer.

### CROSS REFERENCE TO RELATED APPLICATIONS

This application claims priority to Korean Patent Application No. 10-2024-0048002, filed Apr. 9, 2024, the entire contents of which are incorporated herein by reference.

### BACKGROUND

### 1. Technical Field

The present disclosure relates to a thermal management system of a vehicle which is capable of controlling the amount of refrigerant and the system pressure of a refrigerant system according to an operation mode.

### 2. Description of the Related Art

In general, a vehicle is equipped with a thermal management system to perform the whole thermal management of the vehicle. The thermal management system manages the vehicle's interior air conditioning, power electronics (PE) component cooling, and energy required for cooling or heating batteries in the vehicle.

The thermal management system may be defined as a system in a broad sense that includes an air conditioning system for air conditioning and a heating system, a heat pump system, and a temperature control system using a coolant and a refrigerant to perform thermal management such as cooling or heating batteries, components of power electric (PE) systems, and devices.

Commonly, the thermal management system of a vehicle includes a refrigerant system in which a compressor, a condenser, a receiver dryer, an expansion valve, an evaporator, a gas-liquid separator (an accumulator), etc., are connected to each other through a refrigerant line.

The above-described components of the refrigerant system are the main components constituting an air conditioning system for interior cooling, and a refrigerant successively passes through the components while being circulated along the refrigerant line.

In addition, the thermal management system of a vehicle may be operated in a heating mode in which heated air is supplied into the interior space of the vehicle, and a cooling mode (an air conditioning mode) in which cooled air is supplied into the interior space of the vehicle, and a dehumidification mode for removing moisture in the interior space of the vehicle.

Among these modes, when the heating mode is operated, a refrigerant and an electric heater (e.g., a PTC heater) may be used, and when the temperature of the refrigerant is sufficiently high, the interior heating may be performed using the high-temperature refrigerant without an operation of the electric heater.

Meanwhile, in the refrigerant system in which the refrigerant is circulated, there is a problem in which the system efficiency changes during the summer cooling and the winter heating depending on the amount of refrigerant and the system pressure.

The amount of refrigerant injected into the refrigerant system of an electric vehicle is determined by various tests, but there is difficulty in determining the injection amount of the refrigerant in consideration of both cooling and heating. During cooling in the summer, the less the amount of refrigerant and the lower the system pressure, the lower the compressor load, which is advantageous in reducing power consumption.

During heating in the winter, the more the amount of refrigerant and the lower the system pressure, the lower the negative pressure of a heat pump and the more the heat-absorbing efficiency, which is advantageous in improving the system efficiency with the amount of refrigerant and the system pressure.

The statements in this section merely provide background information related to the present disclosure and may not constitute prior art.

### SUMMARY

The present disclosure has been made keeping in mind the above problems occurring in the related art. The present disclosure provides a thermal management system of a vehicle which controls the amount of refrigerant and the system pressure in a refrigerant system depending on an operation mode.

The present disclosure is not limited to the objective mentioned above, and other objectives not mentioned are clearly understood by those who are ordinarily skilled in the art to which the present disclosure belongs (hereinafter, referred to “those skilled in the art”) in the following description.

To achieve the above-described objective, according to an embodiment of the present disclosure, there is provided a thermal management system of a vehicle. The thermal management system may include: a gas-liquid separator configured to perform separation of refrigerant into gas-phase refrigerant and liquid-phase refrigerant; a compressor configured to suck in, compress, and deliver the refrigerant of the gas-liquid separator; an inner condenser configured to perform heat exchange between air and the refrigerant that has been delivered from the compressor; a first expansion valve configured to expand the refrigerant that has passed through the inner condenser; an outer condenser configured to perform heat exchange between air and the refrigerant that has passed through the first expansion valve; and a receiver dryer configured to remove moisture from the refrigerant that has passed through the outer condenser. The thermal management system may further include: a second expansion valve configured to expand the refrigerant that has passed through the receiver dryer; an evaporator performing heat exchange between air and the refrigerant that has passed through the second expansion valve; a storage line connecting the receiver dryer to the gas-liquid separator and enabling the refrigerant to flow by a pressure difference between the receiver dryer and the gas-liquid separator; and a supply line connected from a refrigerant line at an outlet of the compressor to the storage line. The thermal management system may further include: a valve device configured to selectively open or close the storage line and the supply line and configured to control refrigerant storage at the storage line and refrigerant discharge from the storage line to the receiver dryer.

The valve device may be a 3-way valve provided at a connection location where the storage line is connected to the supply line.

In addition, the thermal management system may include a controller configured to control an operation of the valve device. In particular, the controller may control an opening state of the valve device so that the refrigerant storage at the storage line and the refrigerant discharge from the storage line to the receiver dryer may be selectively performed based on cooling and heating modes.

In addition, during cooling, an opening state of the valve device may be controlled to open the storage line between the receiver dryer and the gas-liquid separator and to close the supply line, and the refrigerant of the receiver dryer may flow to the gas-liquid separator by the pressure difference.

The valve device may be controlled to close all flow paths of the storage line and the supply line after a preset time from the time when the storage line is opened.

In addition, during heating, an opening state of the valve device may be controlled to close a flow path at the gas-liquid separator of the storage line and to enable the supply line and a flow path at the receiver dryer of the storage line to communicate with each other, so that at least part of the refrigerant that has been discharged from the compressor may be moved to the storage line at the receiver dryer through the refrigerant line and the supply line and the refrigerant stored in the storage line may be discharged to the receiver dryer.

In addition, the valve device may be controlled to close all flow paths of the storage line and the supply line after a set time from the time when the opening state is controlled so that the supply line and the flow path at the receiver dryer of the storage line may communicate with each other.

In addition, the storage line may be connected to a refrigerant outlet formed at an upper portion of the receiver dryer, and a refrigerant tube constituting the upper inlet may be disposed inside the receiver dryer while extending downwards, and a lower inlet of the refrigerant tube may be located at a lower space inside the receiver dryer.

Accordingly, with the thermal management system according to the present disclosure, the amount of refrigerant in the refrigerant system and the system pressure can be adjusted using the receiver dryer (R/D) depending on an operation mode.

In addition, according to the present disclosure, the efficiency of the thermal management system can be enhanced by adjusting the amount of refrigerant and the system pressure, and the power consumption during the operation of the system can be reduced.

### BRIEF DESCRIPTION OF THE DRAWINGS

FIG. 1 is a circuit diagram illustrating a thermal management system according to an embodiment of the present disclosure.

FIG. 2 is a block diagram illustrating a control element and operation elements of the thermal management system according to an embodiment of the present disclosure.

FIG. 3 is a detailed view illustrating the connection state of a compressor, a gas-liquid separator, and a receiver dryer in an embodiment of the present disclosure.

FIG. 4 is a view illustrating the connection state of an outer condenser and the receiver dryer in an embodiment of the present disclosure.

FIG. 5 is a flowchart illustrating a control process according to an embodiment of the present disclosure.

FIGS. 6 and 7 are views illustrating operation states of the thermal management system according to embodiments of the present disclosure.

The drawings described herein are for illustration purposes only and are not intended to limit the scope of the present disclosure in any way.

### DETAILED DESCRIPTION

Hereinafter, embodiments of the present disclosure are described in detail with reference to accompanying drawings. Specific structural and functional descriptions of the embodiment of the present disclosure disclosed herein are only for illustrative purposes. The present disclosure may be embodied in many different forms without departing from the concept of the present disclosure. The present disclosure is intended to cover not only the representative embodiments, but also various alternatives, modifications, equivalents, and other embodiments that may be included within the spirit and scope of the present disclosure as defined by the appended claims.

It should be understood that, although the terms “first”, “second”, etc., may be used herein to describe various components, these components should not be limited by these terms. These terms are only used to distinguish one component from another component. For instance, a first component discussed below could be termed a second component without departing from the teachings of the present disclosure. Similarly, the second component could also be termed the first component.

It should be understood that when a component is referred to as being “coupled” or “connected” to another component, it can be directly coupled or connected to the other component or intervening components may be present therebetween. In contrast, it should be understood that when a component is referred to as being “directly coupled” or “directly connected” to another component, there are no intervening components present. Other expressions that explain the relationship between components, such as “between”, “directly between”, “adjacent to”, or “directly adjacent to”, should be construed in the same way.

The same reference numerals are used throughout the drawings and description to refer to the same or similar components. The terminology used herein is for the purpose of describing particular embodiments only and is not intended to be limiting. As used herein, the singular forms “a”, “an”, and “the” are intended to include the plural forms as well, unless the context clearly indicates otherwise. It should be further understood that the terms “comprise” and/or “comprising” are inclusive of components, steps, operations, and/or elements thereof, but are not exclusive of one or more other components, steps, operations, and/or elements thereof.

When a component, device, element, or the like of the present disclosure is described as having a purpose or performing an operation, function, or the like, the component, device, or element should be considered herein as being “configured to” meet that purpose or to perform that operation or function.

In the present disclosure, the amount of refrigerant and the system pressure in a refrigerant system are controlled using a receiver dryer. To this end, pressures generated from a gas-liquid separator (an accumulator) and a compressor, specifically a low pressure in the gas-liquid separator and discharge pressure of the compressor, are used to control the pressure in the receiver dryer and the amount of refrigerant.

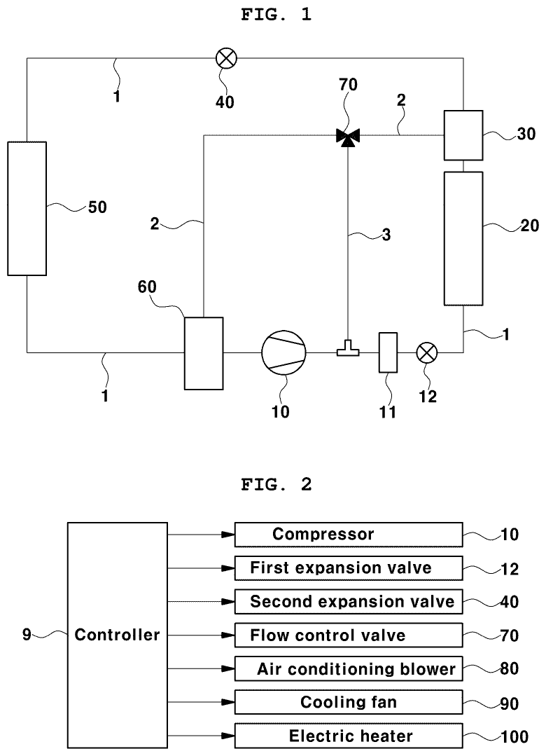

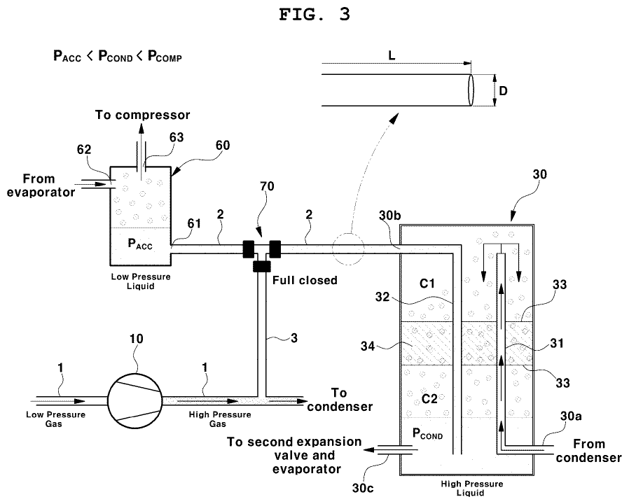

FIG. 1 is a circuit diagram illustrating a thermal management system according to an embodiment of the present disclosure and illustrates a refrigerant system of the thermal management system. In addition, FIG. 2 is a block diagram illustrating a control element and operation elements of the thermal management system according to the embodiment of the present disclosure and also illustrates operation elements of a refrigerant system in addition to a controller 9.

As illustrated in FIGS. 1-2, the refrigerant system includes a compressor 10, an inner condenser 11, a first expansion valve 12, an outer condenser 20, a second expansion valve 40, an evaporator 50, and a gas-liquid separator 60 that enables a refrigerant to pass therethrough in order. The elements of the refrigerant system are connected to each other through a refrigerant line 1 so that the refrigerant passes through the elements in order and circulates.

Gas-liquid separation of the refrigerant is performed in the gas-liquid separator 60, and the compressor 10 sucks the gaseous refrigerant from the gas-liquid separator 60 and compresses the refrigerant into a high-temperature and high-pressure state and then delivers the compressed refrigerant. The refrigerant delivered by the compressor 10 circulates in the entire refrigerant system or a part of the refrigerant system while moving along refrigerant lines 1 to 3.

The refrigerant discharged from the compressor 10 is supplied to the condenser 20 through the refrigerant line 1, then the refrigerant during passing the inside part of the condenser 20 performs heat exchange with air that flows around the condenser 20. The air may be external air sucked by a cooling fan 90.

In addition, the refrigerant having performed heat exchange with the air at the condenser 20 is supplied to the second expansion valve 40 through the refrigerant line 1 and then expands into a low-temperature and low-pressure state during passing through the second expansion valve 40. The second expansion valve 40 may be a mechanical expansion valve or an electronic expansion valve that is operated under the control of the controller 9 and selectively expands the refrigerant.

The low-temperature, low-pressure refrigerant supplied from the second expansion valve 40 through the refrigerant line 1 passes through the evaporator 50. In the evaporator 50, heat exchange occurs between the refrigerant passing through the interior part of the evaporator 50 and the air used for air conditioning flowing around the evaporator 50.

When the air used for air conditioning blowing into an air conditioning casing (not shown) by an air conditioning blower 80 flows around the evaporator 50, the air for air conditioning may be cooled by the low-temperature refrigerant passing through the inside part of the evaporator 50, and the cooled air for air conditioning is discharged into the interior space of the vehicle, thereby achieving the interior cooling.

A receiver dryer 30 configured to remove moisture from the refrigerant is installed on the refrigerant line 1 between the condenser 20 and the second expansion valve 40, and the receiver dryer 30 and the gas-liquid separator 60 are connected to each other so that the refrigerant is movable through a separate refrigerant line 2 (a storage line described below).

In addition, a separate refrigerant line 3 (a supply line described below) branched from the refrigerant line 1 at an outlet of the compressor 10 is connected to the refrigerant line 2 between the receiver dryer 30 and the gas-liquid separator 60 so that the refrigerant is movable through the separate refrigerant line 3.

A flow control valve 70 is installed at a connection location where the refrigerant line 2 between the receiver dryer 30 and the gas-liquid separator 60 connects to the separate refrigerant line 3 branched off from the refrigerant line 1 at the outlet of the compressor 10. The flow control valve 70 may be an electronic 3-way valve of which an opening state is controlled by the controller 9.

In addition, the first expansion valve 12 may be installed on the refrigerant line 1 at an inlet of the condenser 20, and the first expansion valve 12 is an electronic expansion valve that is operated under the control of the controller 9 and selectively expands the refrigerant.

In addition, a condenser 11 in FIG. 1 may be installed in the air conditioning casing, and in the air conditioning casing, an electric heater 100 (e.g., a PTC heater) may be installed instead of the condenser 11 or together with the condenser 11. The condenser 11 and the electric heater 100 may be used during the heating of the vehicle.

When the condenser 20 performing heat exchange with external air sucked by the cooling fan 90 is an outer heat exchanger or an outer condenser, the condenser 11 is a condenser installed inside the air conditioning casing and may be an interior heat exchanger or an inner condenser to perform heat exchange with air used for air conditioning in the air conditioning casing.

Hereinafter, the condenser 20 performing heat exchange with external air sucked by the cooling fan 90 is referred to as “the outer condenser”, and the separate condenser 11 is referred to as “the inner condenser”.

The refrigerant line 1 at the outlet of the compressor 10 may be connected to a refrigerant inlet of the inner condenser 11, and a refrigerant outlet of the inner condenser 11 may be connected to a refrigerant inlet of the first expansion valve 12.

The high-temperature, high-pressure refrigerant compressed by the compressor 10 passes inside the inner condenser 11, and the air for air conditioning blowing by the air conditioning blower 80 and moving along the inside space of the air conditioning casing passes by the inner condenser 11.

Accordingly, when the high-temperature, high-pressure refrigerant passes inside the inner condenser 11, the air for air conditioning passing by the inner condenser 11 may be heated by the refrigerant, and simultaneously the heated air is discharged into the interior space of the vehicle, so that the interior heating is performed.

Likewise, when the electric heater 100 is operated by the controller 9, the air used for air conditioning blowing by the air conditioning blower 80 and moving along the inside part of the air conditioning casing may be heated during passing through the electric heater 100, and simultaneously the interior heating may be performed with heated air discharged to the interior space of the vehicle.

FIG. 2 schematically illustrates controlling, by the controller 9 of the thermal management system of the present disclosure, operations of the compressor 10, the second expansion valve 40, the first expansion valve 12, the flow control valve 70, the air conditioning blower 80, the cooling fan 90, and the electric heater 100.

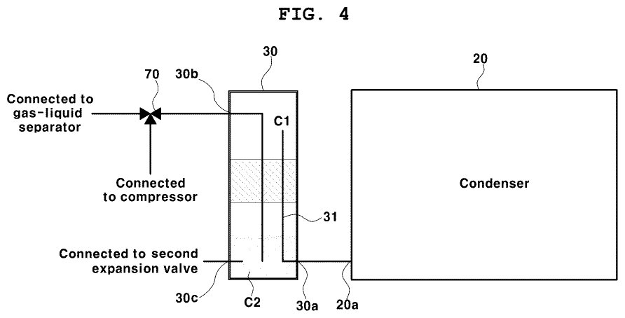

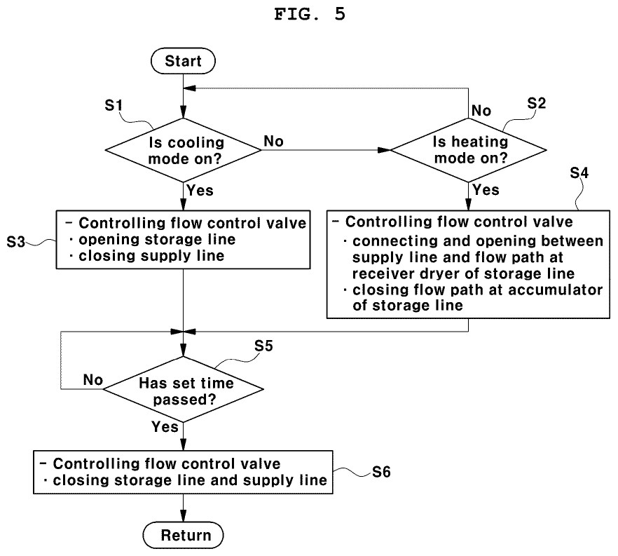

FIG. 3 is a view illustrating the connection state of the compressor, the gas-liquid separator (the accumulator), and the receiver dryer in the embodiment of the present disclosure, and FIG. 4 is a view illustrating the connection state of the outer condenser and the receiver dryer in the embodiment of the present disclosure.

As shown in FIG. 3, the refrigerant lines 1 to 3 are connected to the compressor 10, the receiver dryer 30, and the gas-liquid separator 60 so that the refrigerant is movable among them. The receiver dryer 30 is installed at a refrigerant outlet of the outer condenser 20 or is connected to the refrigerant line 1 (referring to FIG. 1) at the refrigerant outlet, and the receiver dryer 30 serves to remove moisture from the refrigerant supplied from the outer condenser 20.

A refrigerant inlet 30a may be provided at a lower portion of the receiver dryer 30. A first refrigerant tube 31 extends from the refrigerant inlet 30a upwards long (e.g., vertically upward) inside the receiver dryer 30, and an upper outlet of the first refrigerant tube 31 is located at the upper space inside the receiver dryer 30. In one embodiment, the first refrigerant tube 31 may constitute the refrigerant inlet 30a.

In addition, the refrigerant line 2 (hereinafter, referred to as “the storage line”) is connected to a refrigerant outlet 30b formed at an upper portion of the receiver dryer 30 and a first refrigerant inlet 61 of the gas-liquid separator 60 while being located therebetween. A second refrigerant tube 32 extends from the refrigerant outlet 30b downwards long (e.g., vertically downward) inside the receiver dryer 30, and a lower outlet of the second refrigerant tube 32 is located at the lower space inside the receiver dryer 30. In one embodiment, the second refrigerant tube 32 may constitute the refrigerant outlet 30b.

In addition, the separate refrigerant line 3 is branched off from the refrigerant line 1 at the outlet of the compressor 10, and the branched refrigerant line 3 (hereinafter, referred to as “the supply line”) is connected to the storage line 2.

The flow control valve 70 is installed at the storage line 2 and the supply line 3 as a valve device to control the refrigerant storage in the storage line 2 and the refrigerant discharge from the storage line 2 to the receiver dryer 30.

As described above, the flow control valve 70 is installed at the connection portion between the storage line 2 and the supply line 3, and the flow control valve 70 may be an electronic 3-way valve of which the opening state is controlled by the controller 9 in FIG. 2.

A refrigerant outlet 30c is separately installed at the lower portion of the receiver dryer 30, and the refrigerant outlet 30c is connected to the second expansion valve 40 (in FIG. 1) through the refrigerant line 1 (referring to FIG. 1).

Accordingly, the refrigerant discharged through the refrigerant outlet 30c from inside the receiver dryer 30 may be supplied to the evaporator 50 (in FIG. 1) after passing through the second expansion valve 40.

A strainer 33 and a desiccant 34 are installed inside the receiver dryer 30 to partition the inner space into an upper chamber C1 and a lower chamber C2. The first refrigerant tube 31 is installed to pass through the strainer 33 and the desiccant 34, and the upper outlet of the first refrigerant tube 31 is located inside the upper chamber C1.

The second refrigerant tube 32 is also disposed to pass through the strainer 33 and the desiccant 34 in the receiver dryer 30, and the lower inlet of the second refrigerant tube 32 is located inside the lower chamber C2 of the receiver dryer 30. In addition, the refrigerant outlet 30c connected from the receiver dryer 30 to the second expansion valve 40 is also located inside the lower chamber C2.

As illustrated in FIG. 3, the first refrigerant inlet 61 is provided at a lower portion of the gas-liquid separator 60, and a second refrigerant inlet 62 and a refrigerant outlet 63 are provided at an upper portion of the gas-liquid separator 60. As described above, the first refrigerant inlet 61 is connected to the refrigerant outlet 30b of the receiver dryer 30 through the storage line 2.

In other words, the first refrigerant inlet 61 of the gas-liquid separator 60 is connected to the refrigerant outlet 30b of the receiver dryer 30 through the storage line 2 and communicates with the lower space inside the receiver dryer 30 through the second refrigerant tube 32 from the refrigerant outlet 30b, i.e., the lower chamber C2.

In the gas-liquid separator 60, the second refrigerant inlet 62 is connected to a refrigerant outlet of the evaporator 50 through the refrigerant line 1 (referring to FIG. 1), and the refrigerant outlet 63 of the gas-liquid separator 60 is connected to the refrigerant inlet of the compressor 10 through the refrigerant line 1.

In the gas-liquid separator 60, the second refrigerant inlet 62 may be installed at an upper portion of the gas-liquid separator so that the refrigerant that has passed through the evaporator 50 (in FIG. 1) is introduced into an upper space in the gas-liquid separator. In the gas-liquid separator 60, the refrigerant outlet 63 may be installed at the upper portion of the gas-liquid separator so that the gaseous refrigerant in the gas-liquid separator is sucked into the compressor 10.

In the refrigerant system as illustrated in FIG. 3, when the inner pressure of the gas-liquid separator 60 is P_{ACC}, the inner pressure of the receiver dryer 30 is P_{COND}, and the discharge pressure of the compressor 10 is P_{COMP}, the relationship between the pressures is “P_{ACC}<P_{COND}<P_{COMP}”.

In addition, as illustrated in FIG. 3, the storage line 2 between the receiver dryer 30 and the gas-liquid separator 60 may have a refrigerant storage capacity that can be changed according to a length “L” and a diameter “D” of a tube provided and installed as the storage line.

In addition, the lower portion of the receiver dryer 30 is filled with a high-pressure liquid refrigerant, and the lower portion of the gas-liquid separator 60 is filled with a low-pressure liquid refrigerant. When the compressor 10 is driven, the gaseous refrigerant is sucked through the refrigerant outlet 63 of the gas-liquid separator 60 by the compressor. At this point, the compressor 10 sucks in and compresses a low-pressure gaseous refrigerant and discharges the refrigerant into a high-pressure gaseous refrigerant.

Referring to FIG. 4, the connection state between the outer condenser 20 and the receiver dryer 30 is illustrated. As illustrated in FIG. 4, the refrigerant inlet 30a of the receiver dryer 30 is connected to a refrigerant outlet 20a of the outer condenser 20 so that the refrigerant may flow.

As described above, according to the embodiment of the present disclosure, the configuration of the thermal management system, specifically the configuration of the refrigerant system is described. In the present disclosure, the amount of liquid refrigerant in the receiver dryer is adjusted using low pressure generated from the gas-liquid separator and high pressure generated from the compressor of the above-described refrigerant system with control of the flow control valve, thereby adjusting the pressure generated in the system and the amount of refrigerant.

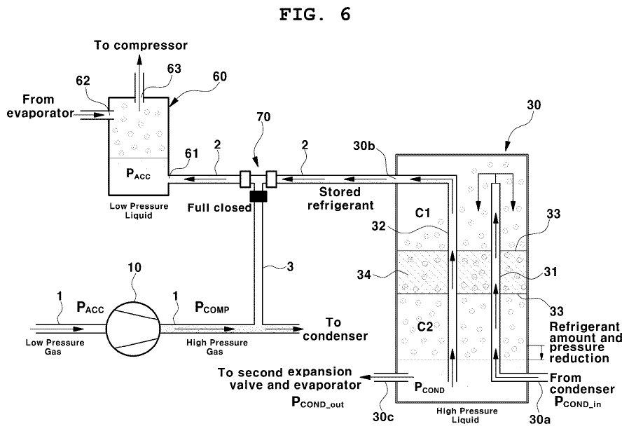

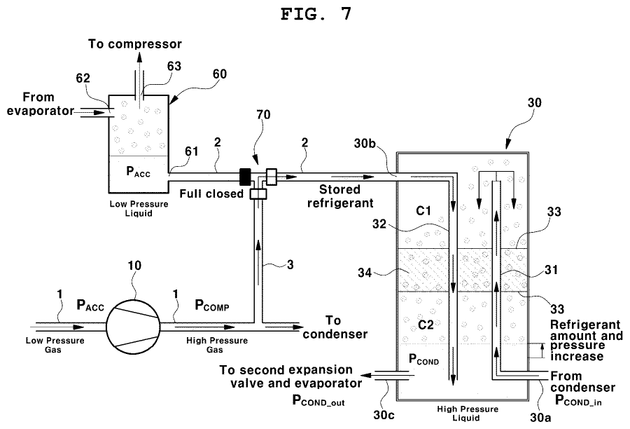

The control and operation state is described with reference to FIGS. 5 to 7. FIG. 5 is a flowchart illustrating a control process according to an embodiment of the present disclosure. FIGS. 6 and 7 are views illustrating the operation states of the thermal management system according to the embodiment of the present disclosure.

In FIGS. 6 and 7, “P_{COND_in}” is the refrigerant inlet pressure of the receiver dryer 30, and “P_{COND_out}” is the refrigerant outlet pressure of the receiver dryer 30. The refrigerant inlet pressure of the receiver dryer 30 is the pressure of the liquid refrigerant introduced through the refrigerant inlet 30a, and the refrigerant outlet pressure of the receiver dryer 30 is the pressure of the liquid refrigerant discharged through the refrigerant outlet 30c.

FIG. 6 is a view illustrating an operation state in the cooling mode in the summer in one embodiment of the present disclosure. Referring to the drawing, a state in which the amount of refrigerant and the pressure of the refrigerant system are controlled is described.

In a refrigerant system of a thermal management system of an electric vehicle, specifically an air conditioning system (cooling and heating system) in the high-temperature environment in the summer, high pressure is generated from a refrigerant so the cooling efficiency in the system is lowered, and a situation where the high pressure of the system should be lowered occurs.

Therefore, in the cooling mode (referring to an operation S1 of FIG. 5), in order to enable the refrigerant to be moved from the receiver dryer 30 to the gas-liquid separator 60 (the accumulator) along the storage line 2, a flow path at the receiver dryer 30 and a flow path at the gas-liquid separator 60 of the storage line 2 are connected to each other and open, and the opening state of the flow control valve 70 is controlled to close a flow path at the supply line 3 by the controller 9 (an operation S3).

As described above, the opening state of the flow control valve 70 is controlled to open the flow path toward the gas-liquid separator 60, so the refrigerant outlet 30b of the receiver dryer 30 and the first refrigerant inlet 61 of the gas-liquid separator 60 communicate with each other through the storage line 2, and the inner lower space (lower chamber, C2) of the receiver dryer 30 and the inner lower space of the gas-liquid separator 60 communicate with each other.

At this point, the relationship among the inner pressure “P_{ACC}” of the gas-liquid separator, the inner pressure “P_{COND}” of the receiver dryer, and the discharge pressure “P_{COMP}” of the compressor is expressed as “P_{ACC}<P_{COND}<P_{COMP}”. In addition, the relationship among the refrigerant inlet pressure “P_{COND_in}” of the receiver dryer 30, the refrigerant outlet pressure “P_{COND_out}” of the receiver dryer 30, and the inner pressure “P_{ACC}” of the gas-liquid separator is presented into “−P_{ACC}+P_{COND_in}−P_{COND_out}=0” and is organized into “P_{COND_out}=P_{COND_in}−P_{ACC}”.

In addition, the refrigerant pressure difference between the low pressure generated in the gas-liquid separator 60 and the high pressure generated in the receiver dryer 30 enables the liquid refrigerant in the receiver dryer 30 to be moved and sucked into the gas-liquid separator 60 through the storage line 2.

As described above, in the cooling mode, the opening state of the flow control valve 70 is controlled by the controller 9 to open the storage line 2 between the receiver dryer 30 and the gas-liquid separator 60, thereby enabling the liquid refrigerant to be moved and sucked in from the receiver dryer 30 to the gas-liquid separator 60.

As the gas-liquid separator 60 sucks in the liquid refrigerant from the receiver dryer 30 as described above, the inner pressure of the receiver dryer may be reduced, and the amount of refrigerant of the system may be reduced. At this point, it is possible to adjust the pressure of the system by the volume of the inner pressure “P_{ACC}” of the gas-liquid separator.

In addition, after a preset time from the time when the storage line 2 is opened, the controller 9 controls the opening state of the flow control valve 70 so that refrigerant flow occurrence is prevented in both the storage line 2 and the supply line 3 (referring in FIG. 3) (operations S5 and S6).

At this point, the opening state of the flow control valve 70 is controlled to close all the flow path at the receiver dryer 30, the flow path at the gas-liquid separator 60, and the flow path at the supply line 3 in the storage line 2. Accordingly, the compressor 10, the receiver dryer 30, and the gas-liquid separator 60 are spatially separated from each other, and it is possible to prevent the occurrence of refrigerant flows among them.

When the opening state of the flow control valve 70 is controlled to open the storage line 2 as described above, a refrigerant flow no longer occurs between the receiver dryer 30 and the gas-liquid separator 60, and there is the effect of storing the refrigerant in the storage line 2 between the receiver dryer 30 and the gas-liquid separator 60. At this point, the capacity of the refrigerant stored in the storage line 2 may be changed according to a length “L” and a diameter “D” of the storage line.

As described above, according to the present disclosure, when the system pressure is increased by the increase of the heat load of the system in the cooling mode in the summer, the liquid refrigerant may flow from the receiver dryer 30 to the gas-liquid separator 60 through the storage line 2 by using the refrigerant pressure difference, and simultaneously the amount of refrigerant in the refrigerant system may be reduced by storing a part of the amount of refrigerant in the storage line 2. In addition, the high-pressure occurrence in the system can be prevented, and the system load can be reduced.

FIG. 7 is a view illustrating an operation state in the heating mode in the winter in an embodiment of the present disclosure. Referring to the drawing, a state in which the amount of refrigerant and the pressure of the refrigerant system are controlled is described.

In low-temperature conditions in the winter, when a heat pump is operated, the pressure generated in the refrigerant system or the amount of refrigerant in the refrigerant system is insufficient, so situations with poor heating efficiency may occur.

Therefore, in the heating mode (referring to an operation S2), the opening state of the flow control valve 70 is controlled in the driving state of the compressor 10 so that at least a part of the high-temperature and high-pressure refrigerant discharged from the compressor 10 may flow from the refrigerant line 1 to the receiver dryer 30 through the supply line 3 and the storage line 2.

At this point, the flow path at the compressor that corresponds to the supply line 3 and the flow path at the receiver dryer of the storage line 2 are connected to each other and open, and the flow control valve 70 is controlled to close the flow path at the gas-liquid separator of the storage line 2 by the controller 9 (an operation S4).

As described above, the opening state of the flow control valve 70 is controlled to open the flow path directed from the compressor 10 to the receiver dryer 30, so the refrigerant outlet of the compressor 10 communicates with the refrigerant outlet 30b of the receiver dryer 30 through the supply line 3 and the storage line 2.

At this point, the relationship among the inner pressure “P_{ACC}” of the gas-liquid separator, the inner pressure “P_{COND}” of the receiver dryer, and the discharge pressure “P_{COMP}” of the compressor is expressed as “P_{ACC}<P_{COND}<P_{COMP}”. In addition, the relationship among the refrigerant inlet pressure “P_{COND_in}” of the receiver dryer 30, the refrigerant outlet pressure “P_{COND_out}” of the receiver dryer 30, and the discharge pressure “P_{COMP}” of the compressor is presented into “P_{COMP}+P_{COND_in}−P_{COND_out}=0” and is organized into “P_{COND_out}=P_{COMP}+P_{COND_in}”.

As described above, when the refrigerant outlet of the compressor 10 and the refrigerant outlet 30b of the receiver dryer 30 communicate with each other, the liquid refrigerant stored in the storage line 2 between the flow control valve 70 and the receiver dryer 30 is pushed by the high-pressure refrigerant discharged from the compressor 10, and simultaneously a refrigerant is additionally supplied into the receiver dryer 30 to increase the amount of refrigerant and the pressure of the system.

Accordingly, the refrigerant may be added into the system with the above-described control, so it is possible to solve negative-pressure and low-pressure states occurring when the heat pump is operated according to heat source shortage in the winter and the shortage problem of the amount of refrigerant in the system, and the heating efficiency is increased with the increase of the inner pressure and the amount of refrigerant in the system, so a cruising distance of the vehicle may also be increased.

Also in the heating mode, after a preset time from the time when the supply line e is opened, the controller 9 may control the opening state of the flow control valve 70 so that refrigerant flow occurrence is prevented in both the storage line 2 and the supply line 3 (referring in FIG. 3) (operations S5 and S6).

Hereinabove, the thermal management system of a vehicle according to the embodiment of the present disclosure has been described in detail. With the above-described thermal management system, the amount of refrigerant in the refrigerant system and the system pressure can be adjusted using the receiver dryer depending on an operation mode.

In addition, with the above-described thermal management system, the efficiency of the thermal management system can be enhanced by adjusting the amount of refrigerant and the system pressure, and the power consumption during the operation of the system can be reduced.

In other words, in cooling, it is possible to restrain the system pressure increase due to the increase of the heat load and the increase of the amount of refrigerant, thereby lowering the condensing pressure, so power consumption can be reduced.

In addition, it is possible to reduce the system negative pressure and the refrigerant amount reduction due to the shortage of heat-absorbing sources during heating, thereby improving the performance of the heat pump, and the heating efficiency can be enhanced.

Hereinabove, although the embodiment of the present disclosure has been described in detail, the right scope of the present disclosure is not limited thereto, and the right scope of the present disclosure also includes various modifications, additions, and substitutions of those skilled in the art, without departing from the scope and spirit of the present disclosure as defined in the accompanying claims.

1. A thermal management system of a vehicle, the thermal management system comprising:
a gas-liquid separator configured to perform separation of refrigerant into gas-phase refrigerant and liquid-phase refrigerant;
a compressor configured to suck in, compress, and deliver the refrigerant of the gas-liquid separator;
an inner condenser configured to perform heat exchange between air and the refrigerant that has been delivered from the compressor;
a first expansion valve configured to expand the refrigerant that has passed through the inner condenser;
an outer condenser configured to perform heat exchange between air and the refrigerant that has passed through the first expansion valve;
a receiver dryer configured to remove moisture from the refrigerant that has passed through the outer condenser;
a second expansion valve configured to expand the refrigerant that has passed through the receiver dryer;
an evaporator performing heat exchange between air and the refrigerant that has passed through the second expansion valve;
a storage line connecting the receiver dryer to the gas-liquid separator and enabling the refrigerant to flow by a pressure difference between the receiver dryer and the gas-liquid separator;
a supply line connected from a refrigerant line at an outlet of the compressor to the storage line; and
a valve device configured to selectively open or close the storage line and the supply line and configured to control refrigerant storage at the storage line and refrigerant discharge from the storage line to the receiver dryer.

2. The thermal management system of claim 1, wherein the valve device is a 3-way valve provided at a connection location where the storage line is connected to the supply line.

3. The thermal management system of claim 1, further comprising:
a controller configured to control an operation of the valve device,
wherein the controller controls an opening state of the valve device so that the refrigerant storage at the storage line and the refrigerant discharge from the storage line to the receiver dryer are selectively performed based on cooling and heating modes.

4. The thermal management system of claim 1, wherein during cooling, an opening state of the valve device is controlled to open the storage line between the receiver dryer and the gas-liquid separator and to close the supply line, and
the refrigerant of the receiver dryer flows to the gas-liquid separator by the pressure difference.

5. The thermal management system of claim 4, wherein the valve device is controlled to close all flow paths of the storage line and the supply line after a preset time from a time when the storage line is opened.

6. The thermal management system of claim 1, wherein, during heating, an opening state of the valve device is controlled to close a flow path at the gas-liquid separator of the storage line and to enable the supply line and a flow path at the receiver dryer of the storage line to communicate with each other, and
at least a part of the refrigerant that has been discharged from the compressor is moved to the storage line at the receiver dryer through the refrigerant line and the supply line and the refrigerant stored in the storage line is discharged to the receiver dryer.

7. The thermal management system of claim 6, wherein the valve device is controlled to close all flow paths of the storage line and the supply line after a set time from a time when the opening state is controlled so that the supply line and the flow path at the receiver dryer of the storage line communicate with each other.

8. The thermal management system of claim 1, wherein the storage line is connected to a refrigerant outlet formed at an upper portion of the receiver dryer, and
a refrigerant tube constituting an upper inlet is disposed inside the receiver dryer while extending downwards, and a lower inlet of the refrigerant tube is located at a lower space inside the receiver dryer.
